(19) United States
(12) Patent Application Publication
(10) Pub. No.: US 2024/0349694 A1
(43) Pub. Date: Oct. 24, 2024

(54) DEVICE AND METHOD FOR INDICATING FED STATUS OF A PET

(71) Applicant: Craig Blum, Tavistock (CA)

(72) Inventor: Craig Blum, Tavistock (CA)

(21) Appl. No.: 18/136,622

(22) Filed: Apr. 19, 2023

(51) Int. Cl. A01K 5/01

(52) U.S. Cl. CPC A01K 5/0114

(57) ABSTRACT

A device for indicating a fed status of a pet includes a housing, a set of indicator members and an actuator mechanism. The device does not require electrical power and can either be mounted to existing food bowls/stands or the housing may include integral food bowls. The device is used to indicate whether a pet has been fed to prevent overeating or undereating. The device is particularly useful for indirectly communicating (via the device) with other members of a household so that anyone viewing the device is able to easily and quickly ascertain whether the pet has been fed and/or how many meals the pet has been fed.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of pet feeding accessories of existing art and more specifically relates to a device used for indicating whether a pet has been fed.

### RELATED ART

According to data, over 60% of Canadian households own at least one dog or cat, and there has been an increase in the pet population in recent years. In 2022, the dog population in Canada increased to 7.9 million from 7.7 million in 2020, and the cat population increased to 8.5 million from 8.1 million in 2020. In the United States, data suggests there are over 48 million dogs providing companionship to their owners. Unfortunately, more than 50% of the dog and cat population in North America are considered obese, which can lead to various health issues. Obesity is the number one health threat that dogs and cats face, and overfeeding is the primary cause.

To prevent this problem, it is recommended that pet owners feed their animals a certain number of times per day based on their age, physical condition, and other factors, in intervals of around 12 hours. However, some animals may suffer from separation anxiety, leading to irregular feeding patterns. This can cause difficulty in keeping track of feeding schedules which results in overfeeding and financial burdens associated with overfeeding and obesity-related health issues. This problem is amplified in households where all members are on conflicting busy schedules and cannot determine whether the pet has already been fed. As a result, many owners end up filling the food bowl regardless of whether the pet has already eaten or not, again resorting to overfeeding and potential health problems for the pet. As such, a suitable solution is desired.

### SUMMARY OF THE INVENTION

In view of the foregoing disadvantages inherent in the known pet feeding accessory art, the present disclosure provides a novel device and method for indicating fed status of a pet. The general purpose of the present disclosure, which will be described subsequently in greater detail, is to provide a device that can be used to indicate whether a pet has been fed, to prevent overeating or undereating. The device may be particularly useful for indirectly communicating (via the device) with other members of a household so that anyone viewing the device is able to easily and quickly ascertain whether the pet has been fed and/or how many meals the pet has been fed.

A device for indicating a fed status of at least one pet is disclosed herein. The device may include a housing, a set of indicator members and an actuator mechanism. Further, in some embodiments, the device may include at least one food bowl disposed at a top side of the housing. The set of indicator members may be disposed at the housing (for example in or on the housing) and each may indicate a different fed status for the at least one pet. The actuator mechanism may be in communication with the set of indicator members and configured to selectively cause independent movement of each of the set of indicator members such that a user is able to visually ascertain the fed status of the at least one pet.

According to another embodiment, a method of using a device for indicating a fed status of a pet is also disclosed herein. The method may include the steps of: providing the device as above, wherein the actuator mechanism includes at least one manually operated control member; feeding the at least one pet; and manually operating the at least one manually operated control member by one of rotating, pressing, toggling (flicking side-to-side or up-and-down), and/or sliding, thereby: moving one of the set of indicator members (that is indicative of the feeding of the at last one pet) such that it is viewable from an exterior of the housing, thereby enabling a user to visually ascertain the fed status of the at least one pet.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a device and method for indicating fed status of a pet, constructed and operative according to the teachings of the present disclosure.

FIG. 1 is a top perspective view of a device including number indicia to indicate a number of meals fed to a pet, according to an embodiment of the disclosure.

FIG. 2 is a top view of the device of FIG. 1 including a rotary control for changing the number indicia, according to an embodiment of the disclosure.

FIG. 3 is a top perspective view of a device including bone indicia to indicate a number of meals fed to a pet, according to an embodiment of the disclosure.

FIG. 4 is a top perspective view of a device including boned shaped members able to be moved from a stowed position to a deployed position to indicate a number of meals fed to a pet, according to an embodiment of the disclosure.

FIG. 5 is a front view of the device of FIG. 4 including a set of levers, lever shafts and connecting rods for moving the bone shaped members from the stowed position to the deployed position, according to an embodiment of the disclosure.

FIG. 6 is a top view of a device including cat-faced members able to be slid along a housing to indicate whether a pet has been fed or not, according to an embodiment of the disclosure.

FIG. 7 is a cross-section view of the device of FIG. 6 taken from line 7-7 in FIG. 6 and demonstrating the cat-faced member attached to the housing, according to an embodiment of the disclosure.

FIG. 8 is a flow diagram illustrating a method of using a device for indicating a fed status of a pet, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a pet feeding accessory and more particularly to a device and method for indicating a fed status of one or more pets. Generally, the device may function as a manual counting system which can be attached to or integrated into feeding bowls or bowl holders/stands. The device may provide members of a household with a visual representation of how many times the pet has been fed. The device may employ any variety of mechanical functions, such as gears, sliding rails, rotary controls, levers, etc. to cause indicator members attached to the mechanical functions to move up and down, side to side, rotate, etc. to display the correct amount of meals fed. The indicator members may employ any variety of numbers, symbols, figures, shapes, etc. to convey the amounts.

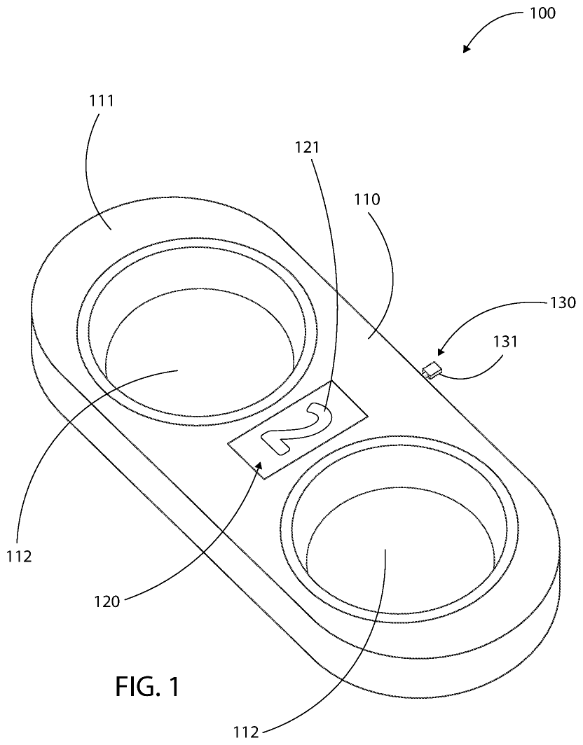

Referring now more specifically to the drawings by numerals of reference, there is shown in FIGS. 1-7, various embodiments of a device for indicating a fed status of at least one pet (“device”). As above, the device may be used for indicating whether one or more pets in a household have been fed their allotted meals. As such, members of the household can easily ascertain whether the one or more pets have been fed, preventing overfeeding or underfeeding thereof.

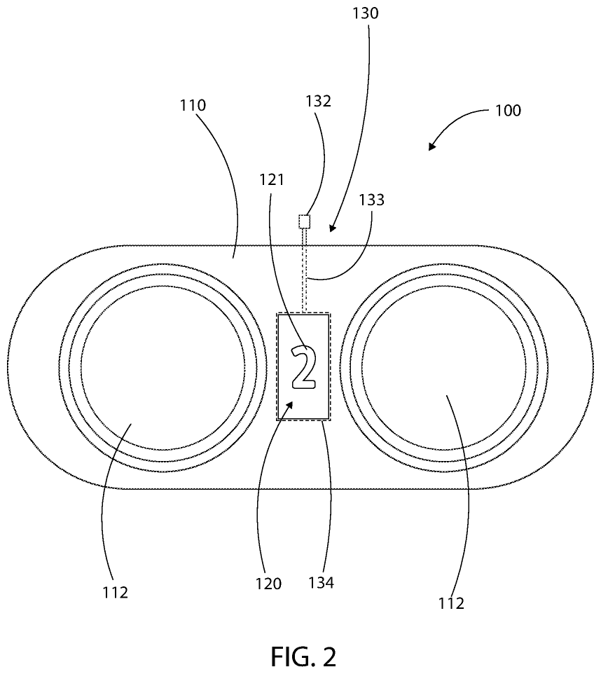

Referring first to FIGS. 1-2, there is shown the device 100 according to some embodiments of the present disclosure. As shown, the device 100 may include a housing 110. In this embodiment, the housing 110 may include a generally planar rectangular cuboid shape, which in some embodiments may include rounded sides. At least one food bowl 112 may be disposed within a top side 111 of the housing 110. For example, as shown in FIGS. 1-2, the top side 111 of the housing 110 may include two food bowls 112 for receiving pet food, or for receiving a removable bowl of pet food. In other embodiments, the housing 110 may be configured to mount to an existing food bowl (not illustrated), a housing thereof, or a surface nearby (such as a wall or floor). For example, the housing 110 may include a bracket, adhesive or other fastener(s) for facilitating this attachment.

A set of indicator members 120 may be disposed at the housing 110 (i.e., in or on the housing 110) and visible from an exterior of the housing 110. For example, as shown here, the set of indicator members 120 may be fixed in the interior of the housing 110 and oriented such that one of the set of indicator members 120 is displayed at a time (viewable from the exterior of the housing 110). The set of indicator members 120 may include (but are not limited to) number indicia, symbol indicia, a shape/indicia representative of an animal feature such as a face, a shape/indicia representative of a pet related item, such as a dog bone, etc. In this embodiment, as shown, the set of indicator members 120 may include number indicia 121.

The set of indicator members 120 may each indicate a different fed status for the at least one pet. Particularly, the set of indicator members 120 together may represent a plurality of allotted meals for the at least one pet, and as such, each of the set of indicator members 120 represent one of the allotted meals. In other words, each indicator member 120 may indicate that a meal has been fed to the at least one pet, so that when one of the members of the household views the device 100, they are able to easily ascertain how many meals the at least one pet has been fed (and thus ascertain whether they need to feed the at least one pet).

As shown in FIG. 2, an actuator mechanism 130 may be in communication with the set of indicator members 120 and configured to selectively cause independent movement of each of the set of indicator members 120 such that a user is able to visually ascertain the fed status of the at least one pet. As shown in FIG. 1, the actuator mechanism 130 may include at least one manually operated control member 131, or as shown here, one manually operated control member 131. Particularly, as shown in FIG. 2, in this embodiment the manually operated control member 131 may include a rotary control 132 (such as a dial or knob) located at the exterior of the housing 110. In this embodiment, as demonstrated in FIG. 2, the actuator mechanism 130 may further include a rotary control shaft 133 (shown via broken lines for clarity as the rotary control shaft 133 is disposed within the interior of the housing 110) attached to the rotary control 132 at one end and attached to the set of indicator members 120 at an opposite end. As such, rotation of the rotary control 132 may cause rotational movement of the set of indicator members 120.

Particularly, the user may manually rotate the rotary control 132, which may cause the indicator member 120 being displayed to change to a different indicator member 120. To achieve this, in some embodiments, the set of indicator members 120 may be provided on a rotating member 134 attached to the rotary control shaft 133. In some examples, the rotating member 134 may include a plurality of sides (or one continuous side in the case of a cylindrical or tubular rotating member) with each side or section of the rotating member 134 including one of the number indicia 121 thereon. For example, one side of the rotating member 134 may include the number “1”; one side may include the number “2”; and one side may include the number “3” (it should however be appreciated that the set of indicator members 120 are not limited to this number). Accordingly, to indicate that the one or more pets have been fed two meals, the user may rotate the rotary control 132 until the number “2” is displayed. In other embodiments, the set of indicator members 120 may each be provided as a separate plate or card attached to a rolling system (not illustrated) configured to selectively roll each one of the plates/cards into view using the rotary control 132.

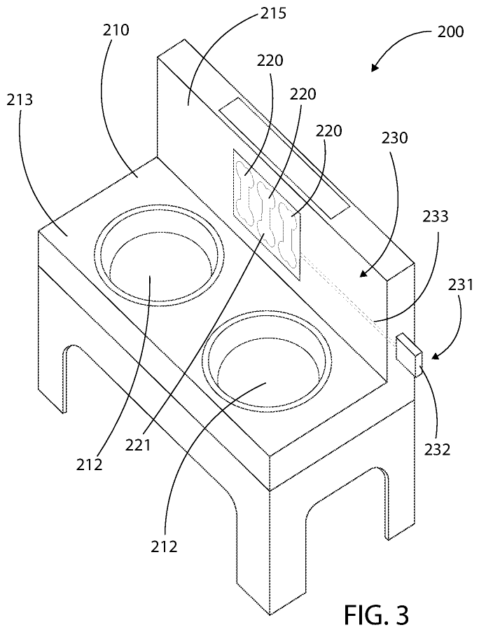

Referring now more specifically to FIG. 3, there is shown the device 200 according to other embodiments of the present disclosure. As shown in this figure, the housing 210 may include a stand 213 having a platform with four legs on which the platform is supported, and a rear display area 215. As shown, the housing 210 again may include at least one food bowl 212, or two food bowls 212, as in the above discussed embodiment. In other embodiments, the housing 210 may be configured to mount about an existing food bowl, a housing thereof, or a surface nearby (such as a wall or floor)—again in some embodiments using bracket, adhesive or other fastener(s) for facilitating this.

The set of indicator members 220 may be disposed within the housing 210. Particularly, as shown in FIG. 3, the set of indicator members 220 may be located within the rear display area 215, either at front side or top side thereof. Similarly to above, the set of indicator members 220 may each indicate a different fed status for the at least one pet and may include (but are not limited to) number indicia, symbol indicia, a shape/indicia representative of an animal feature such as a face, a shape/indicia representative of a pet related item, such as a dog bone, etc. In this embodiment, as shown, the set of indicator members 220 may each include indicia representative of a dog bone 221. Each of the set of indicator members 220 may include a number of dog bones to represent a particular number of meals fed to the at least one pet. For example, one of the set of indicator members 220 may include one bone to represent one meal fed; one of the set of indicator members 220 may include two bones to represent two meals fed, etc.

The actuator mechanism 230 may be in communication with the set of indicator members 220 and configured to selectively cause independent movement of each of the set of indicator members 220 such that a user is able to visually ascertain the fed status of the pet. The actuator mechanism 230 in this embodiment may be largely similar to the actuator mechanism 230 discussed in the embodiment above. Particularly, the actuator mechanism 230 may include one manually operated control member 231 such as a rotary control 232 as above (such as a dial or knob), located at the exterior of the housing 210. Further, the actuator mechanism 230 may include a rotary control shaft 233 (shown via broken lines for clarity in FIG. 3 as the rotary control shaft 233 is disposed within the interior of the housing 210) attached to the rotary control 232 at one end and attached to the set of indicator members 220 at an opposite end. As such, rotation of the rotary control 232 may cause rotational movement of the set of indicator members 220.

Further, in some versions of this embodiment, the set of indicator members 220 may be provided on the rotating member as discussed above (not illustrated) attached to the rotary control shaft 233 with each side including the dog bone indicia (or other pet item indicia). For example, one side of the rotating member may include one dog bone; one side may include two dog bones; and one side may include the three dog bones (it should however be appreciated that the set of indicator members 220 are not limited to this number). As such, to indicate that the one or more pets have been fed two meals, the user may rotate the rotary control 232 until two dog bones are displayed. In other embodiments, the set of indicator members 220 may each be provided as a separate plate or card attached to a rolling system (not illustrated) configured to selectively roll each one of the plates/cards into view using the rotary control 232.

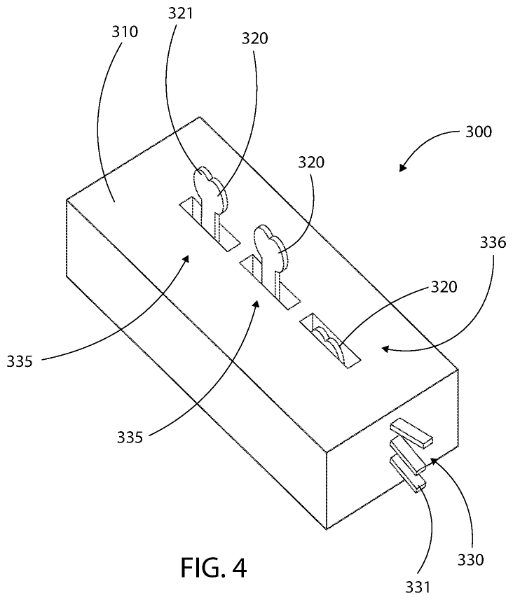

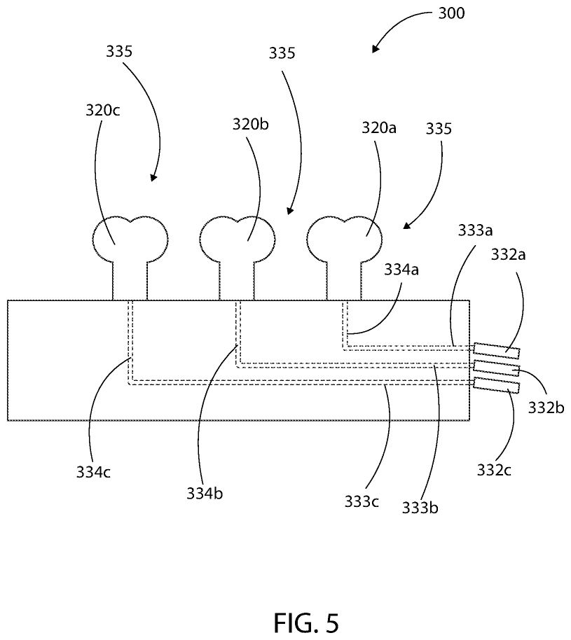

Referring now to FIGS. 4-5, there is shown the device 300 according to another embodiment of the present disclosure. As shown in this embodiment, the housing 310 may include a generally cuboid shape. In some versions, the housing 310 may include at least one food bowl (not illustrated), similar as to what has been discussed above; or in alternative versions, the housing 310 may be attached about an existing food bowl—particularly a housing thereof, or a surface nearby (such as a wall or floor). Again, fasteners may be provided to facilitate this attachment.

The set of indicator members 320 may be disposed within the housing 310 and again may each indicate a different fed status for the at least one pet. As above, the set of indicator members 320 may include (but are not limited to) number indicia, symbol indicia, a shape/indicia representative of an animal feature such as a face, a shape/indicia representative of a pet related item, such as a dog bone, etc. In this embodiment, the set of indicator members 320 may each include a shape and indicia of a dog bone 321. These figures demonstrate three different dog bones which may be used to represent three different meals for the at least one pet; however it should be appreciated that the device 300 is not limited to three indicator members.

Similar to the above discussed embodiments, the actuator mechanism 330 may be in communication with the set of indicator members 320 and configured to selectively cause independent movement of each of the set of indicator members 320 such that a user is able to visually ascertain the fed status of the at least one pet. In this embodiment shown in FIGS. 4-5 and described here, the actuator mechanism 330 may be configured to selectively move each of the set of indicator members 320 from a stowed position 336 within the housing 310, to a deployed position 335 substantially out of the housing 310, as shown particularly in FIG. 4.

To achieve this, the actuator mechanism 330 may include a set of manually operated control members 331. Particularly, the set of manually operated control members 331 may include a set of levers 332a, 332b, 332c. Further, as shown particularly in FIG. 5, the actuator mechanism 330 may include a set of lever shafts 333a, 333b, 333c (shown via broken lines for clarity and to illustrate that they are within the housing 310) each attached to one of the levers 332a, 332b, 332c at one end, and a set of connecting rods 334a, 334b, 334c (again shown via broken lines) each attached to one of the lever shafts 333a, 333b, 333c at an opposite end. The set of connecting rods 334a, 334b, 334c may each be connected to one of the set of indicator members 320a, 320b, 320c. As demonstrated here, the set of levers 332a, 332b, 332c, the set of lever shafts 333a, 333b, 333c and the set of connecting rods 334a, 334b, 334c may include three of each: one for each indicator member 320a, 320b, 320c; however, as above, the set of indicator members 320 are not limited to a particular number.

Toggling (such as flicking the lever up) of each lever 332 may cause either a lateral movement or a vertical movement of a corresponding indicator member 320 (the indicator member 320 in which the toggled lever 332 is attached to via the corresponding lever shaft 333 and the corresponding connecting rod 334). Particularly, depression of each lever 332 may push the opposite end of the lever shaft 333 upward, thus causing the connecting rod 334 to move upward and push the indictor member 320 upward vertically. Accordingly, in one example, to communicate that the at least one pet has consumed one meal, the user may depress one of the levers 332 to cause one of the indicator members 320 to move into the deployed position 335 outside of the housing 310 (and thus readily seen by other members in the household).

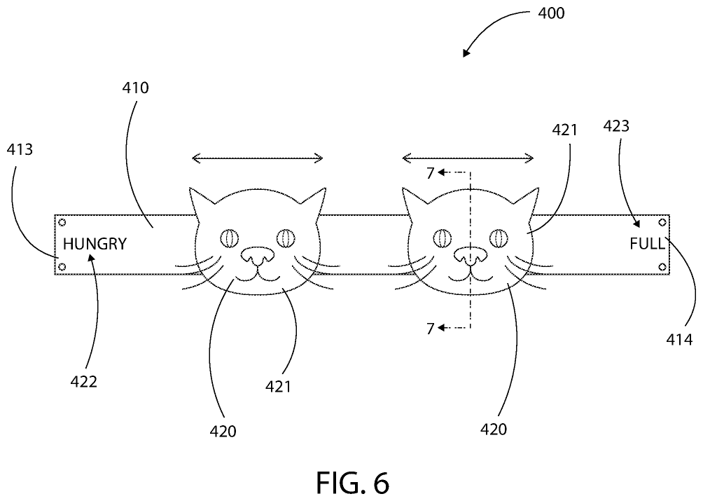

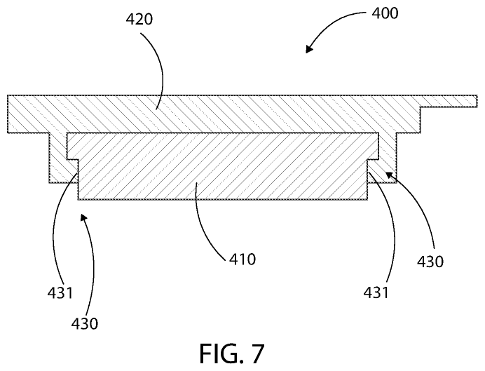

Referring now more specifically to FIGS. 6-7, there is shown the device 400 according to other embodiments of the present disclosure. Again, as above, the housing 410 may be mounted about an existing food bowl; or may include at least one food bowl located therein (not illustrated). As above, the housing 410 may include a bracket, adhesive or other fastener for facilitating this. As shown in this embodiment, the housing 410 may be elongated and generally planar. In this embodiment, the set of indicator members 420 may be disposed atop the housing 410 and again may each indicate a different fed status for the at least one pet.

As above, the set of indicator members 420 may include (but are not limited to) number indicia, symbol indicia, a shape/indicia representative of an animal feature such as a face, a shape/indicia representative of a pet related item, such as a dog bone, etc. Particularly, as shown here, the set of indicator members 420 may include a shape and indicia of a face 421 of a cat or dog. In some versions, as shown in FIG. 6, the device 400 may further include a first indicator indicia 422 at a first side 411 of the housing 410 and a second indicator indicia 423 at a second side 412 of the housing 410. The first indicator indicia 422 may be indicative that the pet needs to be fed. For example, as shown in FIG. 6, the first indicator indicia 422 may include the word “hungry”. The second indicator indicia 423 may be indicative that the pet does not need to be fed. For example, as shown in FIG. 6, the second indicator indicia 423 may include the word “full”.

In this embodiment, as shown in FIG. 7, the actuator mechanism 430 may include a pair of parallel guide-sections 431 (such as tracks) disposed opposite each other in the housing 410 and defining a linear path (between the first side 411 of the housing 410 and the second side 412 of the housing 410). Each of the set of indicator members 420 may be attached to the pair of parallel guide-sections 431 (for example, via clips attached to each of the set of indicator members 420) and able to be manually slid along the linear path. Particularly, the set of indicator members 420 may be configured to be manually slid between the first side 411 and the second side 412 of the housing 410. As such, to indicate that the at least one pet has been fed, the user may slide one of the set of indicator members 420 to the “full” indicia. Accordingly, when members of the household view the device 400, they are able to easily see that the at least one pet has been fed.

It should be appreciated that the different embodiments of the device discussed here are meant to provide a few examples of many different embodiments contemplated. For example, the device 100 shown in FIGS. 1-2 may include bone indicia rather than number indicia; the device 300 shown in FIGS. 4-5 may include a rotary control and rotary control shaft for its actuator mechanism causing rotational movement, rather than levers, lever shafts and connecting rods causing vertical movement, etc. Further, other actuator mechanisms not discussed here may be contemplated. For example, the actuator mechanism may include a series of gears.

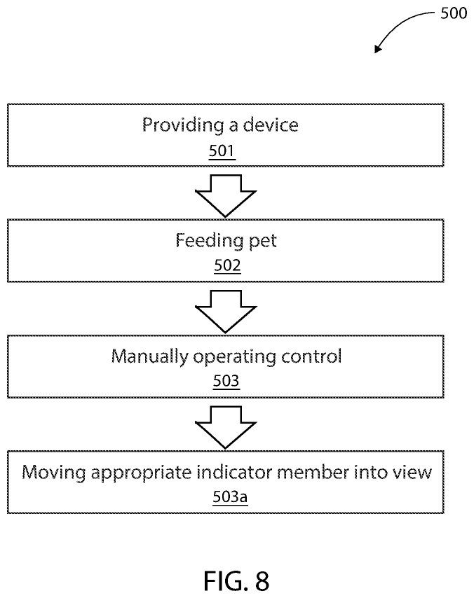

Referring now to FIG. 8 showing a flow diagram illustrating a method 500 of using a device for indicating a fed status of a pet, according to an embodiment of the present disclosure. In particular, the method 500 may include one or more components or features of the device (of various embodiments) as described above. As illustrated, the method 500 may include the steps of: step one 501, providing the device as above (again, of the various embodiments); step two 502, feeding the at least one pet; and step three 503, manually operating the at least one manually operated control member by one of rotating, pressing, toggling (flicking side-to-side or up-and-down), and/or sliding, thereby moving 503a one of the set of indicator members (the particular indicator member that is indicative of the feeding of the at last one pet) such that it is viewable from an exterior of the housing, thereby enabling a user to visually ascertain the fed status of the at least one pet.

The feeding of the at least one pet may be one of a plurality allotted meals for the at least one pet, and as such, the one of the set of indicator members may be indicative of the allotted meal fed to the at least one pet. For example, in some embodiments, if the user feeds the at least one pet their second meal of the day, the user may move an indicator member bearing the number “2” so that it is viewable from the exterior of the housing (e.g., by rotating the set of indicator members until the “2” indicator member is displayed). In another example, in some embodiments, the user may slide an indicator member to the word “full” on the housing.

It should also be noted that the steps described in the method of use can be carried out in many different orders according to user preference. The use of “step of” should not be interpreted as “step for”, in the claims herein and is not intended to invoke the provisions of 35 U.S.C. § 112 (f). It should also be noted that, under appropriate circumstances, considering such issues as design preference, user preferences, marketing preferences, cost, structural requirements, available materials, technological advances, etc., other methods for indicating fed status of at least one pet are taught herein.

It should be noted that, in this specification and the drawings, some elements that have substantially the same function and structure are denoted with the same reference signs, and repeated explanation omitted. It should also be appreciated that common but well understood elements that are useful or necessary in a commercially feasible embodiment are often not depicted throughout in order to facilitate a clearer view of the various embodiments of the present invention.

It should be understood by one of skill in the art that the disclosed invention is described here in a few exemplary embodiments of many. No particular terminology or description should be considered limiting on the disclosure or the scope of any claims issuing therefrom. The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the relevant patent offices and the public generally, and especially the scientist, engineers and practitioners in the art who are not familiar with patent or legal terms or phraseology, to determine quickly from a cursory inspection the nature and essence of the technical disclosure of the application.

What is claimed is:

1. A device for indicating a fed status of at least one pet, the device comprising:
a housing;
a set of indicator members disposed at the housing and each indicating a different fed status for the at least one pet;
an actuator mechanism in communication with the set of indicator members and configured to selectively cause independent movement of each of the set of indicator members such that a user is able to visually ascertain the fed status of the at least one pet.

2. The device of claim 1, further comprising at least one food bowl disposed within a top side of the housing.

3. The device of claim 2, wherein the set of indicator members include number indicia.

4. The device of claim 2, wherein the set of indicator members each include at least one of a shape and indicia representative of an animal feature.

5. The device of claim 2, wherein the set of indicator members each include at least one of a shape and indicia representative of a pet related item.

6. The device of claim 2, wherein the actuator mechanism includes at least one manually operated control member.

7. The device of claim 6, wherein at least one manually operated control member includes a rotary control, wherein the actuator mechanism further includes a rotary control shaft attached to the rotary control at one end and attached to the set of indicator members at an opposite end, and wherein rotation of the rotary control causes rotational movement of the set of indicator members.

8. The device of claim 6, wherein the actuator mechanism is configured to selectively move each of the set of indicator members from a stowed position within the housing, to a deployed position substantially out of the housing, wherein the at least one manually operated control member includes a set of levers, wherein the actuator mechanism further includes a set of lever shafts each attached to one of the levers at one end, and a set of connecting rods each attached to one of the lever shafts at an opposite end, wherein the set of connecting rods are each connected to one of the set of indicator members, and wherein toggling of each lever causes one of a lateral movement and a vertical movement of a corresponding indicator member into the deployed position.

9. The device of claim 6, wherein the actuator mechanism includes a pair of parallel guide-sections disposed opposite each other in the housing and defining a linear path, and wherein each of the set of indicator members are attached to the pair of parallel guide-sections and able to be manually slid along the linear path.

10. The device of claim 9, further comprising a first indicator indicia at a first side of the housing, the first indicator indicia indicative that the pet needs to be fed;
further comprising a second indicator indicia at a second side of the housing, the second indicator indicia indicative that the pet does not need to be fed;
wherein the linear path is between the first side and the second side of the housing; and
wherein the set of indicator members are configured to be manually slid between the first side and the second side.

11. A device for indicating a fed status of at least one pet, the device comprising:
a housing;
at least one food bowl disposed within a top side of the housing;
a set of indicator members disposed at the housing and each indicating a different fed status for the at least one pet;
an actuator mechanism in communication with the set of indicator members and configured to selectively cause independent movement of each of the set of indicator members such that a user is able to visually ascertain the fed status of the at least one pet.

12. The device of claim 11, wherein the set of indicator members include number indicia.

13. The device of claim 12, wherein the set of indicator members each include at least one of a shape and indicia representative of an animal feature.

14. The device of claim 12, wherein the set of indicator members each include at least one of a shape and indicia representative of a pet related item.

15. The device of claim 12, wherein the actuator mechanism includes at least one manually operated control member.

16. The device of claim 15, wherein at least one manually operated control member includes a rotary control, wherein the actuator mechanism further includes a rotary control shaft attached to the rotary control at one end and attached to the set of indicator members at an opposite end, and wherein rotation of the rotary control causes rotational movement of the set of indicator members.

17. The device of claim 15, wherein the actuator mechanism is configured to selectively move each of the set of indicator members from a stowed position within the housing, to a deployed position substantially out of the housing, wherein the at least one manually operated control member includes a set of levers, wherein the actuator mechanism further includes a set of lever shafts each attached to one of the levers at one end, and a set of connecting rods each attached to one of the lever shafts at an opposite end, wherein the set of connecting rods are each connected to one of the set of indicator members, and wherein toggling of each lever causes one of a lateral movement and a vertical movement of a corresponding indicator member into the deployed position.

18. The device of claim 15, wherein the actuator mechanism includes a pair of parallel guide-sections disposed opposite each other in the housing and defining a linear path, and wherein each of the set of indicator members are attached to the pair of parallel guide-sections and able to be manually slid along the linear path.

19. The device of claim 18, further comprising a first indicator indicia at a first side of the housing, the first indicator indicia indicative that the pet needs to be fed;
further comprising a second indicator indicia at a second side of the housing, the second indicator indicia indicative that the pet does not need to be fed;
wherein the linear path is between the first side and the second side of the housing; and
wherein the set of indicator members are configured to be manually slid between the first side and the second side.

20. A method of using a device for indicating a fed status of a pet, the method comprising the steps of:
providing the device comprising:
a housing;
a set of indicator members disposed at the housing and each indicating a different fed status for the at least one pet; and
an actuator mechanism in communication with the set of indicator members and including at least one manually operated control member;
feeding the at least one pet; and
manually operating the at least one manually operated control member by one of rotating, pressing, toggling, and sliding, thereby:
moving one of the set of indicator members, indicative of the feeding of the at least one pet, such that it is viewable from an exterior of the housing, thereby enabling a user to visually ascertain the fed status of the at least one pet.
